(19) United States
(12) Patent Application Publication
(10) Pub. No.: US 2023/0250543 A1
(43) Pub. Date: Aug. 10, 2023

(54) CATALYST LAYER, MEMBRANE ELECTRODE ASSEMBLY

(71) Applicant: TOYOTA JIDOSHA KABUSHIKI KAISHA, Toyota-shi (JP)

(72) Inventor: Joji YOSHIMURA, Toyota-shi (JP)

(73) Assignee: TOYOTA JIDOSHA KABUSHIKI KAISHA, Toyota-shi (JP)

(21) Appl. No.: 18/146,003

(22) Filed: Dec. 23, 2022

(30) Foreign Application Priority Data
Jan. 12, 2022 (JP) 2022-002862

(51) Int. Cl. C25B 11/077; C25B 1/04

(52) U.S. Cl. CPC C25B 11/077; C25B 1/04

(57) ABSTRACT

To enhance water electrolysis efficiency by supporting a catalyst on an oxide carrier at a high density. A catalyst layer includes a carrier and a catalyst. The carrier is a nanosheet made of an oxide containing at least one element selected from Ti, Mn, Co, Mo, Ru, W, Nb, and Ta. The catalyst is supported on the carrier.

### CROSS-REFERENCE TO RELATED APPLICATION

This application claims priority to Japanese Patent Application No. 2022-002862 filed on Jan. 12, 2022, incorporated herein by reference in its entirety.

### TECHNICAL FIELD

The present disclosure relates to a catalyst layer disposed in a membrane electrode assembly used for water electrolysis.

### BACKGROUND

Patent Document 1 discloses supporting Ir and Ru on an inorganic oxide such as titanium oxide. Patent Document 2 discloses coating an electrolyte membrane with IrO₂ by magnetron sputtering. Patent Document 3 discloses depositing platinum layers on both surfaces of an ion exchange membrane by an electroless plating method, and then depositing Ir on the platinum-plated layers by the electroless plating method.

### PRIOR ART DOCUMENTS

### Patent Document

[Patent Document 1] JP 5199575 B
[Patent Document 2] JP H11-279784 A
[Patent Document 3] JP 3855121 B

### SUMMARY OF THE INVENTION

### Problem to Be Solved by the Invention

In a water electrolysis cell for performing water electrolysis, a catalyst used in a catalyst layer which is one layer constituting the water electrolysis cell, is expensive. Therefore, it is desired to reduce the usage of the catalyst while performing efficient water electrolysis or to perform a large amount of water electrolysis with the same catalyst amount.

For efficient water electrolysis, it is effective to impart high activity to the catalyst, and one method for achieving this is to support the catalyst on a stable oxide. However, since a conventional oxide does not have a large surface area, the catalyst cannot be supported at a high density, which makes it difficult to increase the efficiency of water electrolysis.

In view of the above-described problem, it is an object of the present disclosure to enhance water electrolysis efficiency by supporting a catalyst on an oxide carrier at a high density.

### Means for Solving the Problem

The present application discloses a catalyst layer included in a water electrolysis cell. The catalyst layer includes a carrier and a catalyst. The carrier is a nanosheet made of an oxide containing at least one element selected from Ti, Mn, Co, Mo, Ru, W, Nb, and Ta. The catalyst is supported on the carrier.

The carrier may include a material having a photoreducing ability.

The catalyst may include at least one of iridium oxide and ruthenium oxide.

The proportion of the carrier in the catalyst layer may be 50 mass% or less.

Further, the present application discloses a membrane electrode assembly for water electrolysis including a solid polymer electrolyte membrane, an anode catalyst layer stacked on one surface of the solid polymer electrolyte membrane, and a cathode catalyst layer stacked on the other surface of the solid polymer electrolyte membrane. The anode catalyst layer is the catalyst layer described above.

### Effect of the Invention

With the present disclosure, using a layered oxide nanosheet as the carrier increases the surface area of the oxide carrier, allowing the catalyst to be supported on a stable oxide at a high density, and thus high activity can be imparted. This enables efficient water electrolysis, and the amount of the catalyst can be reduced, or a large amount of water electrolysis can be performed even with the same catalyst amount.

### BRIEF DESCRIPTION OF THE DRAWINGS

FIG. 1 is a conceptual diagram illustrating a configuration of a water electrolysis cell 20; and

FIG. 2 is a diagram illustrating a production procedure of a membrane electrode assembly.

### CONFIGURATION FOR IMPLEMENTING THE INVENTION

### 1. Water Electrolysis Cell

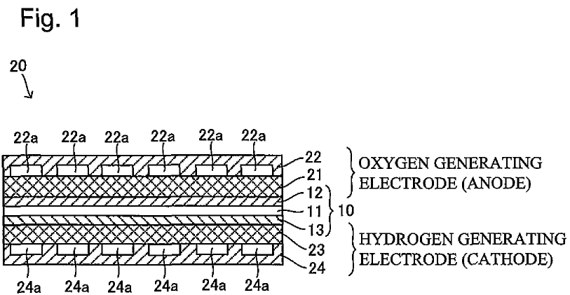

FIG. 1 conceptually shows a configuration of a water electrolysis cell 20. The water electrolysis cell 20 is a unit element for decomposing pure water into hydrogen and oxygen, and a plurality of such water electrolysis cells 20 are stacked to constitute a water electrolysis stack.

The water electrolysis cell 20 includes a plurality of layers, and one of them is an oxygen generating electrode (anode) and the other is a hydrogen generating electrode (cathode) with a solid polymer electrolyte membrane 11 interposed therebetween. In the anode, an anode catalyst layer 12, an anode gas diffusion layer 21, and an anode separator 22 are stacked in this order from the side of the solid polymer electrolyte membrane 11. On the other hand, the cathode includes a cathode catalyst layer 13, a cathode gas diffusion layer 23, and a cathode separator 24 in this order from the side of the solid polymer electrolyte membrane 11. Here, a membrane electrode assembly (MEA) 10 means a stack of the solid polymer electrolyte membrane 11, the anode catalyst layer 12 disposed on the anode side of the solid polymer electrolyte membrane 11, and the cathode catalyst layer 13 disposed on the cathode side of the solid polymer electrolyte membrane 11.

### 1.1. Solid Polymer Electrolyte Membrane

A material (electrolyte) constituting the solid polymer electrolyte membrane 11 is a solid polymer material, and examples thereof include a proton conductive ion exchange membrane formed of a fluorine-based resin, a hydrocarbon-based resin material, or the like. This exhibits excellent proton conductivity (electrical conductivity) in a wet state. More specifically, a membrane made of Nafion (registered trademark), which is a perfluoro-based electrolyte, is included.

### 1.2. Anode Catalyst Layer

In this configuration, the anode catalyst layer (oxygen generating electrode catalyst layer) 12 includes a material in which a catalyst is supported on a carrier made of an oxide nanosheet.

The oxide nanosheet is a nanosheet (two-dimensional structure with a thickness of 1 nm to 100 nm) made of an oxide, and is a layered material. A material forming the oxide nanosheet is desired to be an oxide which is capable of constituting a nanosheet, is inert, and has low solubility in water and in an acidic environment. Specific examples include a nanosheet made of an oxide containing at least one element selected from Ti, Mn, Co, Mo, Ru, W, Nb, and Ta. More specifically, examples of a Ti-based oxide include K₂Ti₄O₉ and K₂La₂Ti₃O₁₀, examples of an Nb-based oxide include KNb₃O₈, K₄Nb₆O₁₇, KLaNb₂O₇, and KSr₂Nb₃O₁₀, examples of a Ta-based oxide include KSr₂Ta₃O₁₀, examples of a TiNb-based oxide include KTiNbOs, examples of a W-based oxide include K₂W₂O₇, and examples of another oxide include KMO₂ (here, M is at least one of Mn, Co, Mo, and Ru).

Further, an oxide nanosheet having a photoreducing ability may be used as the oxide nanosheet. With this, the catalyst can be supported on the oxide nanosheet by photoreduction. Specifically, among the oxides exemplified above, K₂Ti₄O₉, KTiNbOs, K₄Nb₆O₁₇, KLaNb₂O₇, and KSr₂Ta₄O₁₀ are applicable to this.

With the photoreducible oxide nanosheet, when a solution in which the oxide nanosheets and a precursor of the catalyst are dispersed is irradiated with light, electrons and holes are generated on the oxide nanosheet. At that time, the above catalyst is reacted with the electrons and reduced onto the oxide nanosheet, and thus the catalyst is supported on the oxide nanosheet. Supporting by such a method can increase the support amount of the catalyst.

To make sure that the oxide nanosheet has a layered form, it is only necessary to confirm that it has a layered crystal structure by X-ray diffraction (XRD) measurement or the like.

In the layered form of the oxide nanosheet, the length of the longest portion of the layer surface is twice or more the layer thickness, and it may be, for example, 10 times or more or 50 times or more.

As the catalyst contained in the anode catalyst layer 12 and supported on the oxide nanosheet, a known catalyst can be used, and examples thereof include iridium oxide, ruthenium oxide, iridium ruthenium oxide, or a mixture thereof.

Examples of the iridium oxide include iridium oxide (IrO₂, IrO₃), iridium tin oxide, and iridium zirconium oxide.

Examples of the ruthenium oxide include ruthenium oxide (RuO₂, Ru₂O₃), ruthenium tantalum oxide, ruthenium zirconium oxide, ruthenium titanium oxide, and ruthenium titanium cerium oxide.

Examples of the iridium ruthenium oxide include iridium ruthenium cobalt oxide, iridium ruthenium tin oxide, iridium ruthenium iron oxide, and iridium ruthenium nickel oxide.

The catalyst is an electrically conductive oxide material, and a certain degree or more of concentration is required to obtain an appropriate catalytic performance. From such a viewpoint, it is preferred that the proportion of the oxide nanosheet is 50 mass% or less with respect to the total amount of the oxide nanosheet and the catalyst. When the proportion of the oxide nanosheet is larger than 50 mass%, the proportion of the catalyst is relatively reduced, and the electrical conductivity of the catalyst and the electrode may be insufficient.

### 1.3. Cathode Catalyst Layer

As the catalyst contained in the cathode catalyst layer 13, a known catalyst can be used, and examples thereof include platinum, platinum-coated titanium, platinum-supporting carbon, palladium-supporting carbon, cobalt glyoxime, and nickel glyoxime.

### 1.4. Anode Gas Diffusion Layer

The anode gas diffusion layer 21 may be a known one, and is constituted by a member having gas permeability and a conductive property. Specific examples thereof include a porous conductive member made of metal fibers, metal particles, or the like.

### 1.5. Anode Separator

The anode separator 22 may be a known one, and is a member including channels 22a. The channels 22a supply pure water to the anode gas diffusion layer 21 while generated oxygen flows through the channels 22a.

### 1.6. Cathode Gas Diffusion Layer

The cathode gas diffusion layer 23 may be a known one, and is constituted by a member having gas permeability and a conductive property. Specific examples thereof include a porous member such as carbon cloth and carbon paper.

### 1.7. Cathode Separator

The cathode separator 24 may be a known one, and is a member including channels 24a. Separated hydrogen and accompanying water flow through the channels 24a.

### 1.8. Hydrogen Generation by Water Electrolysis Cell

Hydrogen is generated from pure water by the above-described water electrolysis cell 20 as follows. Accordingly, the water electrolysis cell and the water electrolysis stack of the present disclosure can be provided with known members and configurations necessary for generating hydrogen in addition to the above.

Pure water (H₂O) supplied from the channels 22a of the anode separator 22 to the anode (oxygen generating electrode) is decomposed into oxygen, electrons, and protons (H⁺) in the anode catalyst layer 12 that has been subjected to a potential by energizing between the anode and the cathode. At this time, the protons move through the solid polymer electrolyte membrane 11 to the cathode catalyst layer 13. On the other hand, the electrons separated in the anode catalyst layer 12 pass through an external circuit and reach the cathode catalyst layer 13. Then, in the cathode catalyst layer 13, the protons accept the electrons, and hydrogen (H₂) is generated. The generated hydrogen reaches the cathode separator 24 and is discharged from the channels 24a. Note that the oxygen separated in the anode catalyst layer 12 reaches the anode separator 22 and is discharged from the channels 22a.

### 2. Production Method

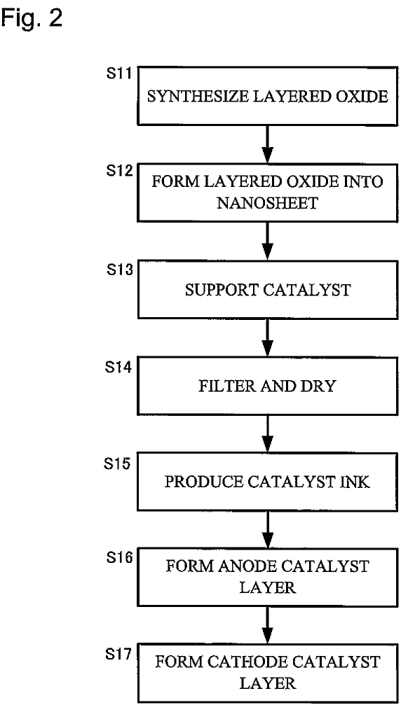

Production of the membrane electrode assembly 10 included in the water electrolysis cell 20 as described above can be performed, for example, as follows. FIG. 2 shows a procedure of the production of the membrane electrode assembly 10. Each step is as follows.

In step S11, a layered oxide is synthesized. The layered oxide is a precursor of the oxide nanosheet that is a carrier included in the anode catalyst layer 12. In the case of KNb₃O₈ given above as one example, the synthesis of the layered oxide can be performed as follows. A mixture of potassium carbonate (K₂CO₃) and niobium oxide (NbO₅) weighed such that K and Nb are in the stoichiometric ratio is heated at 800° C. for 20 hours. Subsequently, the mixture is crushed and mixed, and then further heated for 20 hours.

In step S12, the layered oxide obtained in step S11 is subjected to an alkylammonium treatment to peel off a single layer and form a nanosheet, thereby obtaining an oxide nanosheet.

In step S13, the catalyst is supported on the oxide nanosheet obtained in step S12. A method of supporting may be a known method, and when the oxide nanosheet acts as a photocatalyst, the supporting can be performed by photoreduction.

In step S14, the catalyst-supporting oxide nanosheet in a solution obtained in step S13 is filtered and dried to obtain a composition for the anode catalyst layer.

In step S15, an electrolyte and the composition obtained in step S14 are mixed with a primary alcohol, a secondary or higher alcohol, and water and dispersed to obtain a catalytic ink. Here, examples of the primary alcohol include ethanol, 1-propanol, and 1-butanol, and examples of the secondary or higher alcohol include 2-propanol and t-butyl alcohol. The electrolyte is not particularly limited, but has proton conductivity and may be similar to that of the solid polymer electrolyte membrane 11.

In step S16, the catalyst ink produced in step S15 is applied onto a Teflon (registered trademark) sheet by an applying method such as spraying and dried to obtain a transfer catalyst layer A. The transfer catalyst layer A is stacked on the solid polymer electrolyte membrane 11 and hot-pressed to form the anode catalyst layer 12 on the solid polymer electrolyte membrane 11.

In step S17, carbon supporting a catalyst (such as platinum) for the cathode catalyst layer, an electrolyte, ion-exchanged water, and ethanol are mixed and dispersed to obtain a catalyst ink. The catalyst ink is applied onto a Teflon (registered trademark) sheet by an applying method such as spraying and dried to obtain a transfer catalyst layer B. The transfer catalyst layer B is stacked on a surface of the solid polymer electrolyte membrane 11 opposite to the surface on which the anode catalyst layer 12 is stacked, and hot-pressed to form the cathode catalyst layer 13 on the solid polymer electrolyte membrane 11.

Then, the membrane electrode assembly 10 can be obtained by removing the Teflon (registered trademark) sheet.

### 3. Effects and the Like

With the present disclosure, using the layered oxide nanosheet as the carrier increases the surface area of the oxide carrier, allowing the catalyst to be supported on a stable oxide at a high density, and thus high activity can be imparted. This enables efficient water electrolysis, and the amount of the catalyst can be reduced, or a large amount of water electrolysis can be performed even with the same catalyst amount.

### Description of Symbols

| | |
|---|---|
| 10 | Membrane electrode assembly |
| 11 | Solid polymer electrolyte membrane |
| 12 | Anode catalyst layer (oxygen generating electrode side catalyst layer) |
| 13 | Cathode catalyst layer (hydrogen generating electrode side catalyst layer) |
| 20 | Water electrolysis cell |
| 21 | Anode gas diffusion layer |
| 22 | Anode separator |
| 23 | Cathode gas diffusion layer |
| 24 | Cathode separator |

What is claimed is:

1. A catalyst layer included in a water electrolysis cell, comprising:
a carrier that is a nanosheet made of an oxide containing at least one element selected from Ti, Mn, Co, Mo, Ru, W, Nb, and Ta; and
a catalyst supported on the carrier.

2. The catalyst layer according to claim 1, wherein the carrier includes a material having a photoreducing ability.

3. The catalyst layer according to claim 1, wherein the catalyst includes at least one of iridium oxide and ruthenium oxide.

4. The catalyst layer according to claim 1, wherein a proportion of the carrier in the catalyst layer is 50 mass% or less.

5. A membrane electrode assembly for water electrolysis, comprising:
a solid polymer electrolyte membrane;
an anode catalyst layer stacked on one surface of the solid polymer electrolyte membrane; and
a cathode catalyst layer stacked on the other surface of the solid polymer electrolyte membrane,
wherein the anode catalyst layer is the catalyst layer according to claim 1.
